(19) United States
(12) Patent Application Publication
(10) Pub. No.: US 2019/0392567 A1
(43) Pub. Date: Dec. 26, 2019

(54) Device and Method for Fusing Image Data from a Multi-Camera System for a Motor Vehicle

(71) Applicant: Conti Temic microelectronic GmbH, Nuernberg (DE)

(72) Inventors: Markus FRIEBE, Gefrees (DE); Joerg SCHREPFER, Tettau (DE); Rodrigo GARCIA MARQUES, Bamberg (DE); Martin SIMON, Floh-Seligental (DE); Georg ARBEITER, Kueps (DE); Stefan MILZ, Sallburg-Ebersdorf (DE)

(21) Appl. No.: 16/469,285

(22) PCT Filed: Dec. 5, 2017
(86) PCT No.: PCT/DE2017/200127

§ 371 Date: Jun. 13, 2019

(30) Foreign Application Priority Data
Dec. 14, 2016 (DE) 10 2016 224 905.3

(51) Int. Cl. G06T 5/50; H04N 5/247; B60R 1/00

(52) U.S. Cl. CPC G06T 5/50; H04N 5/247; B60R 1/00; B60R 2300/303; G06T 2207/20221; B60R 2300/105; G06T 2207/30252

(57) ABSTRACT

A device (1) for fusing image data from a multi-camera system (100) for a motor vehicle includes: an image analysis device (10) configured to define subregions (TB1, TB2, . . . , TBn) of an overlap region (ÜB) of at least two cameras (110, 120) of the multi-camera system; an acquisition device (20) configured to acquire pixel densities of the subregions (TB1, TB2, . . . , TBn) of the overlap region; and a computing device (30) configured to determine pixel density deviations and to select adjacent subregions (TB1, TB2, . . . , TBn) with deviations below a threshold value for a total image overlay.

### TECHNICAL FIELD

The present invention relates to image processing systems for driver assistance systems for motor vehicles.

In particular, the present invention relates to a device and a method for fusing image data from a multi-camera system for a motor vehicle.

### TECHNICAL BACKGROUND

Multi-camera systems in motor vehicles constitute an enhanced acquisition of the surrounding area compared with what would be possible with a single camera.

Multi-camera systems are mostly installed in motor vehicles such that camera constellations with overlapping views are created.

In today's vehicle-based surround view systems, the overlapping fields of view of the adjacent cameras which occur are frequently already manually configured during the production of the motor vehicle.

The disadvantage is that this always requires a manual configuration for each vehicle variant and is therefore rather time-consuming and costly.

The manual configuration results in a sudden alteration in the image resolution in the overlapping image regions, i.e. there is a so-called fading from an increased pixel density to a lower pixel density, as depicted in FIG. 1.

### SUMMARY OF THE INVENTION

It is an object of the present invention to provide an improved device and an improved method for fusing image data from a multi-camera system for a motor vehicle.

This object is achieved by the subject matter of the independent claims. Further developments and embodiments can be inferred from the dependent claims, the description and the figures of the drawings.

A first aspect of the present invention relates to a device for fusing image data from a multi-camera system for a motor vehicle. The device comprises an image analysis device, an acquisition device, and a computing device.

The image analysis device is designed to define subregions of an overlap region of at least two cameras of the multi-camera system. The subregions are formed individually for each individual image acquisition by each camera and for each subregion.

The acquisition device is designed to acquire pixel densities of the subregions of the overlap region.

The computing device is designed to determine pixel density deviations and to select adjacent subregions with deviations below a threshold value for a total image overlay.

The present invention advantageously makes it possible to carry out an improved image data fusion, by estimating intrinsic and extrinsic camera data and automatically selecting subregions with pixel density values which are the same—at least approximately the same—as can be predefined by the threshold value. Primarily, adjacent subregions can be checked for pixel densities.

The image resolution therefore alters less in the overlapping regions and fusion artifacts are reduced.

A further second aspect of the present invention relates to a motor vehicle having a multi-camera system and a device according to the first aspect or according to any embodiment of the first aspect.

A further aspect of the present invention relates to a method for fusing image data from a multi-camera system for a motor vehicle. The method comprises the following method steps:

As a first step of the method, subregions of an overlap region of at least two cameras of the multi-camera system are defined.

As a further, second step, the method comprises acquiring pixel densities of the subregions of the overlap region.

As a further, third step, the method comprises determining pixel density deviations and selecting adjacent subregions for a total image overlay, wherein the selected adjacent subregions have deviations below a threshold value.

Advantageous configurations of the present invention can be inferred from the subordinate claims.

In an advantageous embodiment of the present invention, it is provided that the computing device is designed to carry out the total image overlay of the image data of the at least two cameras of the multi-camera system.

This advantageously makes it possible to provide an improved fusion of the image data of the multi-camera system for the motor vehicle.

In a further advantageous embodiment of the present invention, it is provided that the acquisition device is designed to acquire the area covered by a subregion per area unit on an image sensor of the at least two cameras as the pixel densities.

This advantageously makes it possible to avoid an image artifact of the fused total image.

In a further advantageous embodiment of the present invention, it is provided that the computing device is designed to carry out an alpha blending of the image data of the at least two cameras of the multi-camera system as the total image overlay.

The term “alpha blending” as used by the present invention, describes, for example, a technology in image or video processing in which various images are overlaid to form a total image, wherein the alpha channel can also be considered in addition to the color information.

The described configurations and further developments can be combined in any way with one another.

Further possible configurations, further developments and implementations of the present invention also comprise combinations of features of the present invention, which are described above or below with respect to the embodiments, including those which are not explicitly indicated.

The appended drawings are intended to provide a further understanding of the embodiments of the present invention.

The appended drawings illustrate embodiments and, in connection with the description, serve to explain concepts of the present invention.

Other embodiments and many of the indicated advantages are set out with respect to the figures of the drawings. The depicted elements of the figures of the drawings are not necessarily shown to scale with respect to one another.

### BRIEF DESCRIPTION OF THE FIGURES

FIG. 1: shows a schematic representation of an image data fusion in order to explain the present invention;

FIG. 2: shows a schematic representation of a multi-camera system according to a further exemplary embodiment of the present invention;

FIG. 3: shows a schematic representation of a device for fusing image data from a multi-camera system for a motor vehicle according to a further exemplary embodiment of the present invention; and

FIG. 4: shows a schematic representation of a flow diagram of a method for fusing image data from a multi-camera system for a motor vehicle for a motor vehicle according to a further exemplary embodiment of the present invention.

### DETAILED DESCRIPTION OF THE EXEMPLARY EMBODIMENTS

In the figures of the drawings, the same reference numerals denote elements, parts, components or method steps which are the same or which have the same function, unless otherwise indicated.

The motor vehicle or vehicle is, for example, a motor vehicle or a hybrid vehicle, for example a hybrid vehicle having a coasting function, for example a motorcycle, a bus or a truck or a bicycle.

The term “pixel density” as used by the present invention is, for example, defined as an image area of a subregion of the image per area unit on an image sensor, as used by the image sensor in order to portray the image area of the subregion.

Driver assistance systems are electronic additional apparatuses in motor vehicles for supporting the driver in certain driving situations.

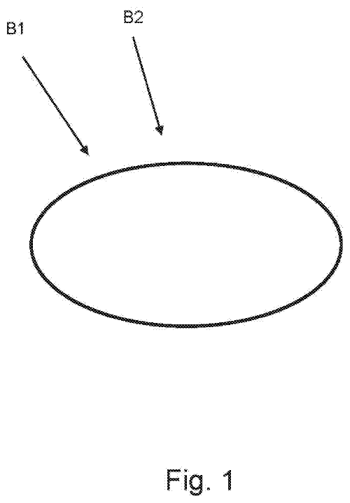

FIG. 1 shows a schematic representation of an image data fusion in order to explain the present invention.

The manual configuration during the fusion of image data from multi-camera systems mostly results in an abrupt alteration in the image resolution in the overlapping image regions, i.e. there is a so-called fading from an increased pixel density to a lower pixel density, as depicted in FIG. 1.

The two arrows represent regions having a different pixel density. For example, a first region B1 having a high pixel density and an adjacent second region B2 having a reduced pixel density are formed. In the transition between the individual images as captured by the individual cameras, this results in image artifacts during the fusion of the total image.

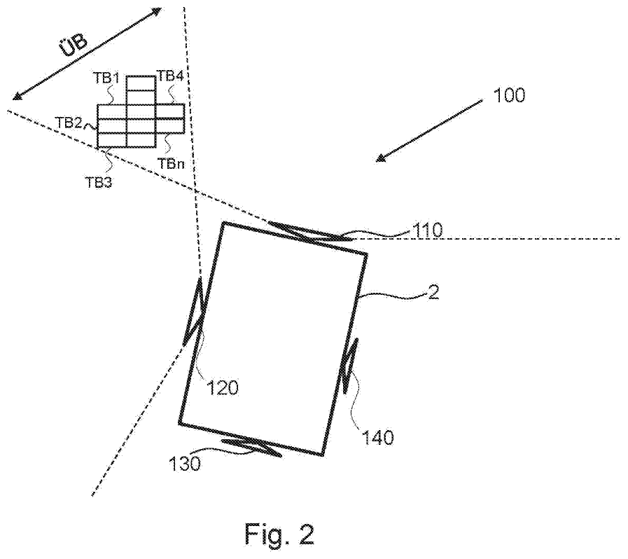

FIG. 2 shows a schematic representation of a multi-camera system according to a further exemplary embodiment of the present invention.

The motor vehicle 2 comprises a multi-camera system 100 with four cameras, a first camera 110, a second camera 120, a third camera 130 and a fourth camera 140.

The cameras 110, 120, 130, 140 have different, however at least partially overlapping, fields of view, as depicted by dashed lines.

The overlap region ÜB of the fields of view of the first camera 110 and the second camera 120 can be subdivided into subregions TB1, TB2, . . . , TBn.

The subregions TB1, TB2, . . . , TBn can also be called subregions. The subregions TB1, TB2, . . . , TBn can be formed, for example, for each camera, i.e. as depicted for the first camera 110 and the second camera 120.

In other words, both the field of view of the first camera 110 and the field of view of the second camera 120 are divided into subregions TB1, TB2, . . . , TBn within the overlap region ÜB.

The total image as a fusion of the fields of view produces, for example, a surround view or a panoramic view image.

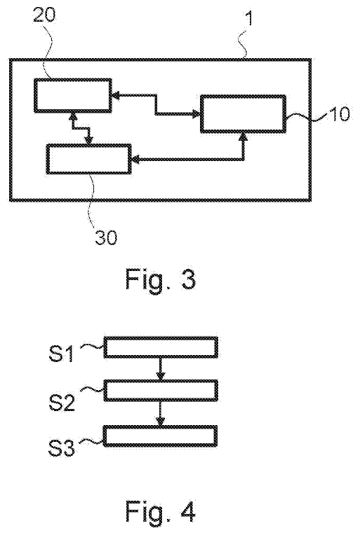

FIG. 3 shows a schematic representation of a device for fusing image data from a multi-camera system for a motor vehicle according to a further exemplary embodiment of the present invention.

The device 1 for fusing image data from a multi-camera system 100 for a motor vehicle 2 comprises an image analysis device 10, an acquisition device 20 and a computing device 30.

The image analysis device 10 is designed to define subregions TB1, TB2, . . . , TBn of an overlap region ÜB of at least two cameras 110, 120 of the multi-camera system 100.

The acquisition device 20 is designed to acquire pixel densities of the subregions TB1, TB2, . . . , TBn of the overlap region ÜB.

The computing device 30 is designed to determine pixel density deviations and to select adjacent subregions TB1, TB2, . . . , TBn with deviations below a threshold value for a total image overlay.

FIG. 4 shows a schematic representation of a flow diagram of a method for fusing image data from a multi-camera system for a motor vehicle for a motor vehicle according to a further exemplary embodiment of the present invention.

The method comprises the following method steps:

As a first step of the method, subregions TB1, TB2, . . . , TBn of an overlap region OB of at least two cameras 110, 120 of the multi-camera system 100 are defined S1.

As a second step of the method, pixel densities of the subregions TB1, TB2, . . . , TBn of the overlap region ÜB are acquired S2.

As a third step of the method, pixel density deviations are determined S3 and adjacent subregions TB1, TB2, . . . , TBn are selected for a total image overlay, wherein the selected adjacent subregions have deviations below a threshold value.

Although the present invention has been described above on the basis of preferred exemplary embodiments, it is not restricted to these, but can be modified in many ways. In particular, the invention can be amended or modified in multiple ways without deviating from the core of the invention.

In addition, it is pointed out that “comprising” and “having” do not exclude any other elements or steps and “a” or “one” does not exclude a plurality.

It is additionally pointed out that features or steps, which have been described with reference to one of the above exemplary embodiments, can also be used in combination with other features or steps of other exemplary embodiments described above. Reference numerals in the claims are not to be viewed as restrictions.

1. A device for fusing respective image data from at least two cameras of a multi-camera system for a motor vehicle, the device comprising:
an image analysis device configured to define subregions of an overlap region of the at least two cameras of the multi-camera system;
an acquisition device configured to acquire respective pixel densities of the subregions of the overlap region; and
a computing device configured to determine pixel density deviations among the pixel densities of the subregions, and to select, for a total image overlay of the respective image data from the at least two cameras, adjacent ones of the subregions of which the respective pixel density deviations fall below a threshold value.

2. The device according to claim 1, wherein the computing device is configured to produce the total image overlay of the image data of the at least two cameras by fusing the selected adjacent subregions.

3. The device according to claim 1, wherein the acquisition device is configured to acquire, as a respective one of the pixel densities, an area covered by a respective one of the subregions per unit area on an image sensor of the at least two cameras.

4. The device according to claim 1, wherein the computing device is configured to perform an alpha blending of the image data of the at least two cameras to produce the total image overlay.

5. A motor vehicle comprising a vehicle body, a multi-camera system and a device according to claim 1.

6. A method of fusing respective image data from at least two cameras of a multi-camera system for a motor vehicle, comprising the following method steps:
defining subregions of an overlap region of the at least two cameras of the multi-camera system;
acquiring respective pixel densities of the subregions of the overlap region; and
determining pixel density deviations among the pixel densities of the subregions, and selecting, for a total image overlay of the respective image data from the at least two cameras, adjacent ones of the subregions of which the respective pixel density deviations fall below a threshold value.

7. The method according to claim 6, further comprising producing the total image overlay of the image data of the at least two cameras by fusing the selected adjacent subregions.

8. The method according to claim 6, wherein the acquiring of the respective pixel density comprises acquiring an area covered by a respective one of the subregions per unit area on an image sensor of the at least two cameras.

9. The method according to claim 6, further comprising producing the total image overlay by performing an alpha blending of the image data of the at least two cameras.
